(19) United States
(12) Patent Application Publication
(10) Pub. No.: US 2004/0122758 A1
(43) Pub. Date: Jun. 24, 2004

(54) Budget and financial analysis system and method

(76) Inventor: Juei-Mei Wang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/680,352

(22) Filed: Oct. 6, 2003

(30) Foreign Application Priority Data
Dec. 20, 2002 (TW) 91136950

(51) Int. Cl. G06F 17/60

(52) U.S. Cl. 705/35

(57) ABSTRACT

A system for budget and financial analysis includes client computers (10), an application server (12), and a database (14). The application server includes a basic information maintaining module (21) for maintaining basic information; a new account setting module (22) for setting accounts' initial balances; a journal voucher registering module (23) for registering journal vouchers according to source materials; a carrying forward module (24) for automatically carrying forward accounts and data of journal vouchers to corresponding accounts of a ledger; a budget module (25) for setting budget information of accounts and maintaining budget columns of accounts; a calculating module (26) for calculating financial ratios; and a statement generating module (27) for generating statements. The database stores data generated during these processes. The client computers are connected to the application server through an electronic network (11). The application server is connected to the database through a connection (13).

### BACKGROUND OF THE INVENTION

1. Field of the Invention

The present invention relates to a budget and financial analysis system and method, and particularly to a budget and financial analysis system and method that can define financial ratio analysis items and formulas and compare actual data with budget data.

2. Background of the Invention

Efficient financial management is vital for vast multinational manufacturing corporations. The object of financial statement analysis is to assess the present financial situation and business performance, and to forecast the future financial situation and business performance. Financial budget analysis examines the differences between actual expenses and budgeted expenses, in order to improve budget-making capabilities. Financial statement analysis and financial budget analysis are essential tools for enterprise decision-makers. There is vast range of financial budget and analysis software available in the marketplace. However, these programs are generally not flexible enough when calculating financial ratios, and lack adequate functions for comparing actual expenses with budgeted expenses.

Computer-aided financial management systems are disclosed in a number of patents. U.S. pat. Publication Ser. No. 4,953,085 issued on Aug. 28, 1990 and entitled “System for the Operation of a Financial Account” discloses a system for users to define and show their financial objectives, risks preferences, and financial forecasts and budget limitations, in addition to providing loan account management. The system can help users monitor statuses of their assets and liabilities. However, the system does not provide the functions of financial ratio analysis and comparison between actual and budgeted expenses.

### SUMMARY OF THE INVENTION

Accordingly, a main objective of the present invention is to provide a budget and financial analysis system and method, whereby users can define financial ratio analysis items and formulas to satisfy their own requirements.

Another objective of the present invention is to provide a budget and financial analysis system and method which can provide budget management functions and generate statements comparing budgets with actual expenses.

A further objective of the present invention is to provide a budget and financial analysis system and method which can connect to other systems and retrieve needed information therefrom automatically.

To accomplish the above objectives, a budget and financial analysis system in accordance with a preferred embodiment of the present invention includes a plurality of client computers, an application server, and a database. Each client computer provides a user interface for inputting and displaying basic information. The application server includes: a basic information maintaining module for maintaining basic information; a new account setting module for setting accounts' initial balances; a journal voucher registering module for registering journal vouchers according to source materials generated during business activities; a carrying forward module for automatically carrying forward accounts and data of journal vouchers to corresponding accounts of a ledger; a budget module for setting budget information and maintaining budget columns of accounts; a calculating module for calculating financial ratios; a statement generating module for generating statements. The database stores all kinds of data generated during the above-described processes. The client computers are connected to the application server through an electronic network. The application server is connected to the database through a connection.

Further, the present invention provides a budget and financial analysis method comprising the steps of: (a) setting basic information through a user interface; (b) determining whether the system is being run for the first time, if it is, setting each account's initial balance by way of inputting corresponding data manually; (c) determining whether there is an external financial system, If there is, automatically obtaining accounts and data from the external financial system and entering the accounts and data to corresponding columns of journal vouchers; if there isn't, manually inputting accounts and data to corresponding columns of journal vouchers according to source materials; (d) carrying forward accounts and data of journal vouchers to corresponding accounts of a ledger; (e) determining whether there is an external budget system, if there is, automatically obtaining budget data from the external budget system and entering the budget data to budget columns of corresponding accounts of the ledger; if there isn't, manually inputting budget data to budget columns of corresponding accounts of the ledger; (f) calculating financial ratios required by a user; and (g) generating corresponding statements.

Other objects, advantages and novel features of the present invention will be drawn from the following detailed description with reference to the attached drawings, in which:

### BRIEF DESCRIPTION OF THE DRAWINGS

FIG. 1 is a schematic diagram of hardware infrastructure of a budget and financial analysis system in accordance with the preferred embodiment of the present invention;

FIG. 2 is a schematic diagram of main function units of an application server of the budget and financial analysis system of FIG. 1; and

FIG. 3 is a flowchart of a preferred method for implementing the budget and financial analysis system of the present invention.

### DETAILED DESCRIPTION OF THE INVENTION

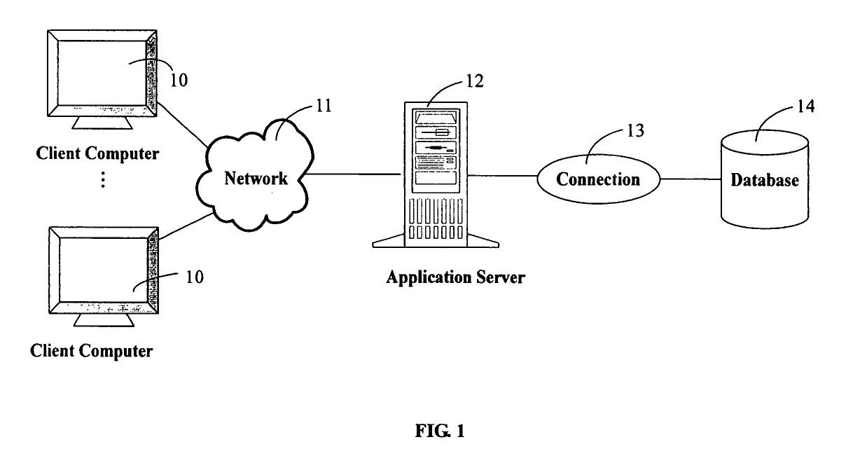

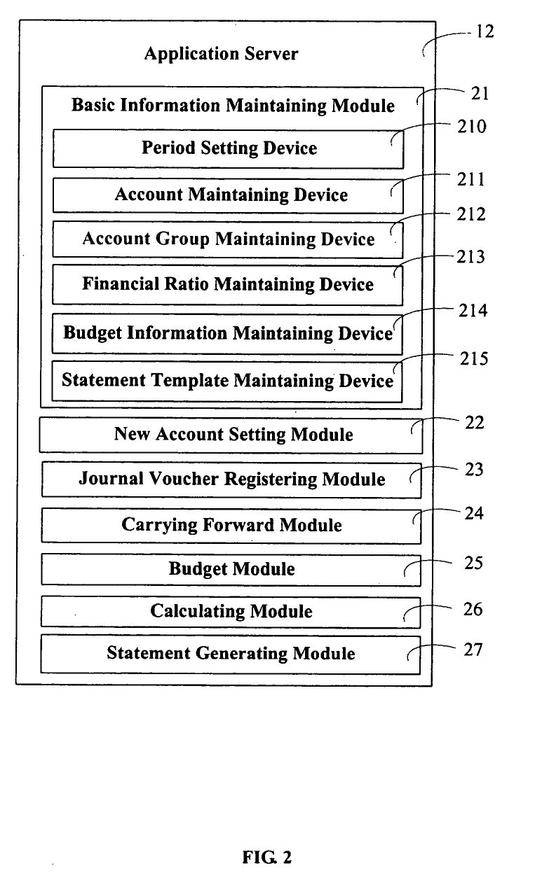

FIG. 1 is a schematic diagram of hardware infrastructure of a budget and financial analysis system in accordance with the preferred embodiment of the present invention. The budget and financial analysis system comprises a plurality of client computers 10, an application server 12, and a database 14. The client computers 10 are connected to the application server 12 through an electronic communications network 11. The network 11 may be any suitable communication architecture required by the budget and financial analysis system, such as a local area network, a wide area network, etc. The application server 12 is connected to the database 14 through a connection 13. The connection 13 is a database connectivity such as an Open Database Connectivity (ODBC) or a Java Database Connectivity (JDBC). Each client computer 10 provides an interactive user interface for users to maintain basic information and view statements. The application server 12 comprises a plurality of function units (described in detail below in relation to FIG. 2). The application server 12 can retrieve and analyze data obtained from the client computers 10 and from other systems such as an external financial system (not shown) and an external budget system (not shown), process the data, and display processing results through the client computers 10. The external financial system is for providing financial information, and may include an accounts payable management system, an accounts receivable management system, a bill management system, and a fixed asset management system. The external budget system is for providing budget information. The database 14 stores all kinds of data generated during the above-described processes.

FIG. 2 is a schematic diagram of main function units of the application server 12. The application server 12 comprises a basic information maintaining module 21, a new account setting module 22, a journal voucher registering module 23, a carrying forward module 24, a budget module 25, a calculating module 26, and a statement generating module 27.

The basic information maintaining module 21 maintains basic information, including by way of adding, modifying, searching and deleting basic information. The basic information may include accounting periods, accounts, account groups, financial ratios, budget information and statement templates, all of which are described in more detail below. The basic information maintaining module 22 comprises and executes a period setting device 210, an account maintaining device 211, an account group maintaining device 212, a financial ratio maintaining device 213, a budget information maintaining device 214, and a statement template maintaining device 215. The period setting device 210 is used for setting accounting periods. This allows a user to define a particular financial period to generate an individualized statement. The accounting period may for example be a monthly or quarterly period, or a calendar or fiscal year. The account maintaining device 211 is for maintaining accounts, account structures, and account segments. Said accounts include two columns: one for actual balances and one for budget balances. Each account structure is a relationship between a main account and one or more subsidiary accounts. Each subsidiary account is controlled by the main account. For example, the main account may be accounts payable, and a subsidiary account may be the account payable of a particular supplier. An account segment refers to a configuration of an account. Customarily, an account can be divided into four segments, and each segment can be designated with a different number in accordance with different needs. For example, a user may define the first segment as a main account, the second segment as a subsidiary account, the third segment as a department code, and the fourth segment as a product code. The account group maintaining device 212 is for grouping accounts according to main accounts or subsidiary accounts. When grouping is based on main accounts, the group includes at least one main account. When grouping is based on subsidiary accounts, the group includes at least one subsidiary account. For example, a user can define the accounts whose first segment is 03 as a grouping basis. Thus the total of balances of the accounts included in this group indicate a balance of the main account that is represented by 03. Groupings are convenient for calculating balances and generating individualized statements. The financial ratio maintaining device 213 maintains financial ratio information, which includes financial ratio items and formulas. The statement template maintaining device 215 maintains types and forms of statements. The types of statements mainly include balance sheets, consolidated balance sheets, consolidated profit and loss accounts, consolidated cash flow statements, key ratio statements, real-budget comparison statements, expense comparison statements, profit comparison statements, etc.

The new account setting module 22 is used for setting a new account's initial balance. When the budget and financial analysis system is run for the first time, the new account module 22 sets each account's initial balance after corresponding data has been input manually. The corresponding data are obtained from former financial account information and other sources such as bills of lading.

The journal voucher registering module 23 registers journal vouchers according to source materials generated during business activities. A journal voucher is a kind of voucher that is designed by an enterprise itself to record business activities by entry of information according to source materials. The journal voucher typically records accounting parameters including dates, accounts, balances, exchange rates, currencies, totals, ID numbers and quantities of corresponding source materials, persons in charge, and auditors. The purpose of registering is to fill in blanks of the journal vouchers. If there is an external financial system, the journal voucher registering module 23 automatically obtains accounts and data from the external financial system, and enters the accounts and data to corresponding columns of the journal vouchers. If there is no external financial system, a user manually inputs accounts and data to corresponding columns of the journal vouchers according to source materials. The accounts and data of journal vouchers are stored in the database 14.

The carrying forward module 24 automatically carries forward accounts and data of journal vouchers to corresponding accounts of a ledger, and generates debit or credit balances of accounts that are stored in the database 14. Each journal voucher has a column indicating whether the journal voucher has been carried forward. Users can query journal vouchers that have not been carried forward through the client computers 10, in order to determine whether the accounts of the ledger are correct.

The budget module 25 is used for setting budget information and maintaining budget columns of accounts. The budget information may for example include budget periods, budget items, and accounts. If there is an external budget system, the budget module 25 automatically obtains budget data from the external budget system, and enters the budget data to budget columns of corresponding accounts. If there is no external budget system, a user manually inputs budget data to budget columns of corresponding accounts.

The calculating module 26 is for calculating financial ratios. The calculating module 26 retrieves actual balances and budget balances of accounts from the database 14, retrieves financial ratio items and formulas from the financial ratio maintaining device 213, and calculates financial ratios required by users.

The statement generating module 27 generates statements according to predefined statement templates and particular terms set by respective users. The terms set by a user may be account segments or account groups. For example, the statement generating module 27 can generate a financial statement of a department by way of collecting balances of accounts whose segment represent the department. Another example is, when an expense comparison statement comparing expenses between departments is needed, the statement generating module 27 selects the group that represents the selected expense, and then collects balances of accounts whose third segments represent a certain department. In this way, the statement generating module 27 retrieves the expense of each department, and generates the expense comparison statement.

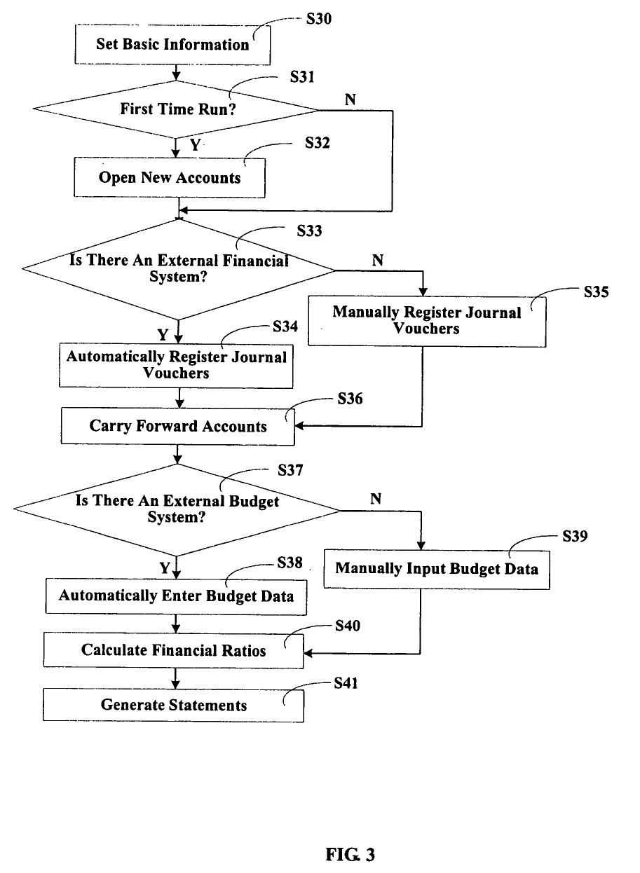

FIG. 3 is a flowchart of a preferred method for implementing the budget and financial analysis system of the present invention. In step S30, the basic information maintaining module 21 sets basic information such as accounting periods, accounts, account groups, financial ratios, budget information, and statement templates. The basic information as set is stored in the database 14, and can be searched by any user through any client computer 10. In step S31, a user determines whether the system is being run for the first time. If the system is not being run for the first time, the procedure goes directly to step S33 described below. If the system is being run for the first time, in step S32, the new account module 22 sets each new account's initial balance by way of inputting corresponding data manually, whereupon the procedure goes to step S33. In step S33, the user determines whether there is an external financial system. If there is an external financial system, in step 34, the journal voucher registering module 23 automatically obtains accounts and data from the external financial system, and enters the accounts and data to corresponding columns of journal vouchers. If there is no external financial system, in step S35, the user manually inputs accounts and data to corresponding columns of journal vouchers according to source materials. After that, in step 36, the carrying forward module 24 automatically carries forward accounts and data of journal vouchers to corresponding accounts of a ledger, and generates debit or credit balances of accounts that are stored in the database 14. In step S37, the user determines whether there is an external budget system. If there is an external budget system, in step S38, the budget module 25 automatically obtains budget data from the external budget system, and enters the budget data to budget columns of corresponding accounts of the ledger. If there is no external budget system, in step S39, the user manually inputs budget data to budget columns of corresponding accounts of the ledger. In step S40, the calculating module 26 retrieves actual balances and budget balances of accounts from the database 14, retrieves financial ratio items and formulas from the financial ratio maintaining device 213, and calculates financial ratios required by the user. Finally, in step S41, the statement generating module 28 generates corresponding statements. The statements can be displayed to the user through the interface of the relevant client computer 10, stored in the database 14, and printed.

Although the present invention has been specifically described on the basis of a preferred embodiment and a preferred method, the invention is not to be construed as being limited thereto. Various changes and modifications may be made to the embodiment and method without departing from the scope and spirit of the invention.

What is claimed is:

1. A budget and financial analysis system, in which users can define their own financial ratio analysis items and formulas, the budget and financial analysis system comprising:
a plurality of client computers, each of the client computers providing a user interface for inputting and displaying data;
a database for storing information; and
an application server comprising:
a basic information maintaining module for adding, modifying, searching and deleting basic information;
a journal voucher registering module for registering journal vouchers according to source materials generated during business activities;
a carrying forward module for automatically carrying forward accounts and data of journal vouchers to corresponding accounts of a ledger, and generating debit or credit balances of accounts;
a budget module for setting budget information of accounts and maintaining budget columns of accounts;
a calculating module for calculating financial ratios; and
a statement generating module for generating statements according to predefined statement templates and particular terms set by respective users.

2. The budget and financial analysis system according to claim 1, wherein the basic information maintaining module comprises:
a period setting device for setting accounting periods;
an account maintaining device for maintaining accounts;
an account group maintaining device for grouping accounts;
a financial ratio maintaining device for maintaining financial ratio information; and
a statement template maintaining device for maintaining types and forms of statements.

3. The budget and financial analysis system according to claim 2, wherein the account maintaining device maintains accounts, account structures, and account segments.

4. The budget and financial analysis system according to claim 1, wherein the types of statements include any one or more of balance sheets, consolidated balance sheets, consolidated profit and loss accounts, consolidated cash flow statements, key ratio statements, real-budget comparison statements, expense comparison statements, profit comparison statements.

5. A budget and financial analysis method, comprising the steps of:
setting basic information through a user interface;
determining whether there is an external financial system for providing financial information;
obtaining accounts and data from the external financial system and entering the accounts and data to corresponding columns of journal vouchers automatically, if there is an external financial system;
carrying forward accounts and data of journal vouchers to corresponding accounts of a ledger;
determining whether there is an external budget system;
obtaining budget data from the external budget system and entering the budget data to budget columns of corresponding accounts of the ledger, if there is an external budget system;
calculating financial ratios; and
generating corresponding statements.

6. The method according to claim 5, further comprising the steps of:
determining whether the system is being run for the first time; and
setting each account's initial balance by way of inputting corresponding data manually, if the system is being run for the first time.

7. The method according to claim 5, further comprising the step of manually inputting accounts and data to corresponding columns of journal vouchers according to source materials, if there is no external financial system.

8. The method according to claim 5, further comprising the step of manually inputting budget data to budget columns of corresponding accounts of the ledger, if there is no any external budget system.

9. A budget and financial analysis system, in which users can define their own financial ratio analysis items and formulas, the budget and financial analysis system comprising:
means for adding, modifying, searching and deleting basic information;
means for registering journal vouchers according to source materials generated during business activities;
means for automatically carrying forward accounts and data of journal vouchers to corresponding accounts of a ledger, and generating debit or credit balances of accounts;
means for setting budget information of accounts and maintaining budget columns of accounts;
means for calculating financial ratios; and
means for generating statements including said financial ratios.
